(19) United States
(12) Patent Application Publication
(10) Pub. No.: US 2007/0203912 A1
(43) Pub. Date: Aug. 30, 2007

(54) Engineering manufacturing analysis system

(76) Inventors: Matthew L. Thuve, Huntington Beach, CA (US); Michael Ganowsky, Anaheim, CA (US); Louis Alvarez, Corona, CA (US); Leonard Rosenblum, Fullerton, CA (US)

Correspondence Address: INGRASSIA FISHER & LORENZ, P.C. (BOEING), 7150 E. CAMELBACK RD., SUITE 325, SCOTTSDALE, AZ, 85251, US

(21) Appl. No.: 11/363,878

(22) Filed: Feb. 28, 2006

(51) Int. Cl. G06F 17/30

(52) U.S. Cl. 707/10

(57) ABSTRACT

A network based and automated engineering manufacturing analysis system as described herein is configured to manage producibility characteristics of a project or program throughout the lifecycle of the project or program. The system utilizes a collaborative data relationship and management tool that maintains metadata to create relationships between different information types for the project or program. The system relies upon real-time collaborative status updates that identify whether participants (e.g., vendors, designers, suppliers, and manufacturers) are satisfying requirements related to producibility characteristics. One example system designates a set of specified requirements for each project milestone level, and expects participants to provide electronic files, documents, or artifacts that evidence satisfaction of such requirements. The system processes requirement status updates in substantially real-time such that all participants can view the current project health and status at any time during the lifecycle of the project.

### STATEMENT REGARDING FEDERALLY SPONSORED RESEARCH OR DEVELOPMENT

This invention was made with United States Government support under contract number DAAE07-03-9-F001 awarded by the United States Army. The United States Government has certain rights in this invention.

### TECHNICAL FIELD

Embodiments of the present invention relate generally to the management and processing of data. More particularly, embodiments of the present invention relate to a software tool that enables the collaborative, systematic, and automated tracking, linking, and analysis of data and information from multiple sources. For example, a system according to the invention can be used in the measurement and analysis of production readiness throughout a manufacturing program or product lifecycle.

### BACKGROUND

Managing large projects of design, development, and manufacturing which involve multiple partners, suppliers, manufacturers, and multiple products is like managing a plurality of islands. These islands are typically self-contained, but seldom do they understand their relationship to each others' products, services and they do not see the impact of their work on the entire project. There is also a lack of collaborative problem solving and risk management.

Historically, manufacturing success has been measured in terms of producibility, where producibility generally relates to whether something can be manufactured or deployed repeatedly, affordably, reliably, and efficiently. Conventional techniques for measuring producibility rely on the manual, time consuming, and sporadic generation of status reports, which typically coincide with milestone design reviews that occur during the lifetime of the project. Such conventional techniques can be cumbersome and difficult to manage, particularly for complex projects that may include hundreds or thousands of parts and assemblies, and/or many different vendors, suppliers, or partners. Moreover, such conventional methods rely on the infrequent generation and analysis of status reports, which do not provide an accurate real-time assessment of the project health at any given time.

Previous producibility measurement approaches are time consuming, labor intensive, and reactive in nature, thus resulting in delayed reaction to manufacturing problems and issues. Existing producibility measurement methodologies are not very systematic, quantitative, or automated. In this regard, they do not provide a convenient diagnostic tool that measures and analyzes production readiness throughout the overall program and/or product lifecycle. Moreover, existing solutions do not provide for collaborative status reporting and analysis of data related to producibility. Rather, such existing solutions typically rely on status reports and infrequent design review meetings that do not involve both engineering/design team members and manufacturing team members.

Accordingly, it is desirable to have a software based tool that provides a predictive capability to isolate systemic engineering and manufacturing problems related to production readiness and technology maturation. In addition, it is desirable to have a software based tool that enables collaborative analyses (both specific and systemic) and provides diagnostics to mitigate the earliest effects of program lifecycle costs. Furthermore, other desirable features and characteristics of embodiments of the present invention will become apparent from the subsequent detailed description and the appended claims, taken in conjunction with the accompanying drawings and the foregoing technical field and background.

### BRIEF SUMMARY

An engineering manufacturing analysis system (“EMAS”) configured in accordance with an example embodiment of the invention addresses an aspect of industrial product engineering and development that essentially does not have focus on concurrent engineering-manufacturing maturity and readiness. Such an EMAS addresses a desirable state of concurrent engineering-manufacturing maturity and readiness through an objective-based software tool that specifically assesses key elements. Further, a software based EMAS can be constructed such that it operates in real time, is easy to use, and provides a vast number of assessment views. The EMAS allows a user to perform objective assessments of the health of a manufacturing program at any time during the production cycle. In addition, the EMAS has the intelligence to suggest remedies to specific assessment feedback (e.g., a low score in a particular area can be remedied by taking certain actions).

The above and other aspects of the invention may be carried out in one embodiment by a collaborative data relationship and management method. The method involves: maintaining a data mapping structure having a plurality of addressable nodes, each having metadata associated therewith, and each being addressable through a plurality of address elements corresponding to different information types, the metadata for each of the plurality of addressable nodes indicating information about at least one member of a group; analyzing the metadata for each of the plurality of addressable nodes against a respective set of requirements; and providing a result in response to the analyzing step.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a data management system configured in accordance with an example embodiment of the invention;

FIG. 2 is a diagram that depicts an example relationship network that may be maintained by the data management system shown in FIG. 1;

FIG. 3 is a diagram that depicts example relationship network cells that may be maintained by the data management system shown in FIG. 1;

FIG. 3A is a diagram that depicts example relationship networks that may be maintained by the data management system shown in FIG. 1;

FIG. 4 is a schematic representation of a network-deployed EMAS configured in accordance with an example embodiment of the invention;

FIG. 5 is a schematic representation of an example program manager system suitable for use in the EMAS shown in FIG. 4;

FIG. 6 is an example logical requirements structure that may be utilized by an EMAS;

FIG. 7 is a relationship diagram depicting logical and functional links between elements, features, and components of an example EMAS;

FIG. 8 is a table of sample data and information handled by an example EMAS;

FIG. 9 is a flow chart of an example EMAS setup process; and

FIG. 10 is a flow chart of an example EMAS process.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of computing system environments and that the system described herein is merely one example embodiment of the invention.

For the sake of brevity, conventional techniques related to data processing, database management, computer network communication, manufacturing engineering, producibility assessment, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

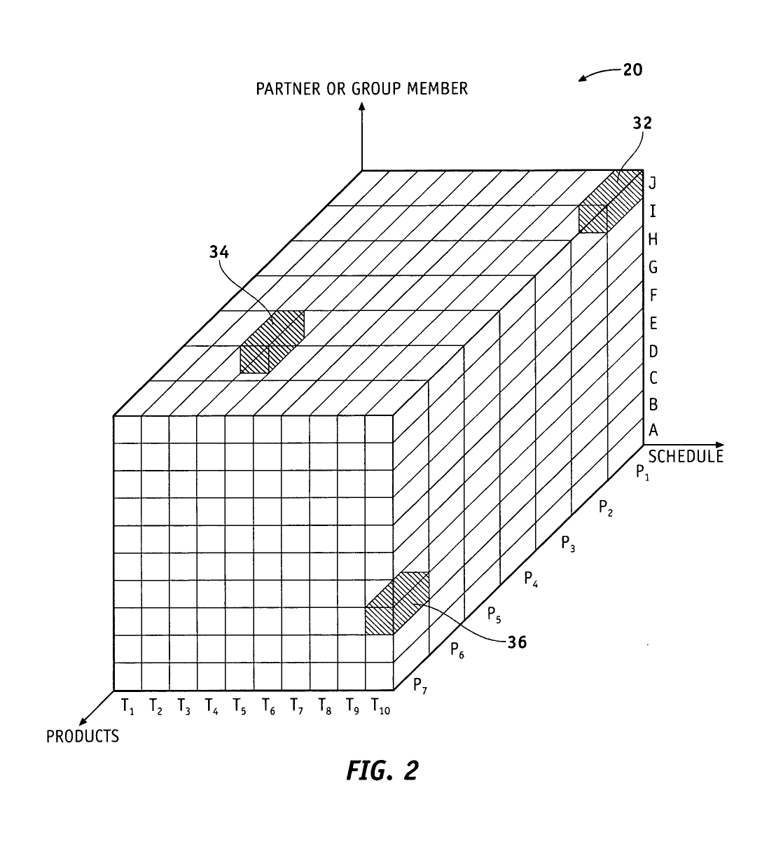

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 2, for example, depicts one example arrangement of elements, additional intervening elements, devices, features, or components may be present in an embodiment of the invention (assuming that the functionality of the system is not adversely affected).

### Definitions

Metadata—Information about data. Metadata describes, points to, identifies, or relates to other data.

Producibility—The relative ease of producing an item, product, or system that is governed by the characteristics and features of a design that enable economical fabrication, assembly, inspection, and testing using available production technology.

Engineering Manufacturing Readiness Level (“EMRL”)—An EMRL is a defined level in a manufacturing process that is utilized to measure the maturity of a party's engineering and manufacturing processes to transition to production, where a “party” may be a supplier, a vendor, a designer, a system integrator, or any participant or provider that contributes to the completion of a project. As used herein, a lower EMRL indicates an earlier stage in the project life cycle, while a higher EMRL indicates a later stage in the project life cycle.

Criteria—The term criteria refers to categories of manufacturing readiness requirements that are specified for a given EMRL. In the example embodiment, a criteria corresponds to a root grouping of metrics and requirements, where each criteria may have one or more associated metrics.

Metric—A metric is generally considered to be any measurable quantity, aspect, feature, element, or characteristic. In the example embodiment, a metric corresponds to a sub-grouping of the criteria, and the root grouping of the requirements, where each metric may have one or more associated requirements.

Requirement—A requirement is anything that is needed to satisfy a metric and/or a criteria. In the example embodiment, each requirement is unique to its associated EMRL, criteria, and metric.

Artifact—An artifact is a document, a file, an application, or other piece of evidence that contributes to the satisfaction of at least one requirement. A direct artifact is an artifact that is specifically created or generated to satisfy a stated requirement. A supporting artifact is an artifact that also has applicability and context outside the scope of the specific project and was not specifically created or generated to satisfy any particular requirement.

A system as described in more detail herein can be deployed in a manufacturing or design context where multiple partners contribute to the completion of a project or a program. The system allows partners to continue to do what they do without changing any of their internal systems, but it also allows them to see how they impact others by the product they produce, their development schedules, their product availability, etc. In addition, the system allows them to see the impact of the other partners' work on them and allows them to adjust, adapt, and change to optimize their profitability and resources. This visibility allows insights to common risks and/or challenges across products, systems, and the supply chain both internal and external (partners, venders, subcontractors, etc.)

Typically, an exceptional contractor may have some insight to the challenges its suppliers are facing but the suppliers may not be aware of this knowledge. The system described herein allows real-time input and feedback on project/program requirements as the work is being performed. The real time access to the artifacts and statuses and the ability to map statuses to requirements, products, schedules, and the like provide a mechanism to identify risks, perform trend analysis, and identify solutions or possible sources of solutions.

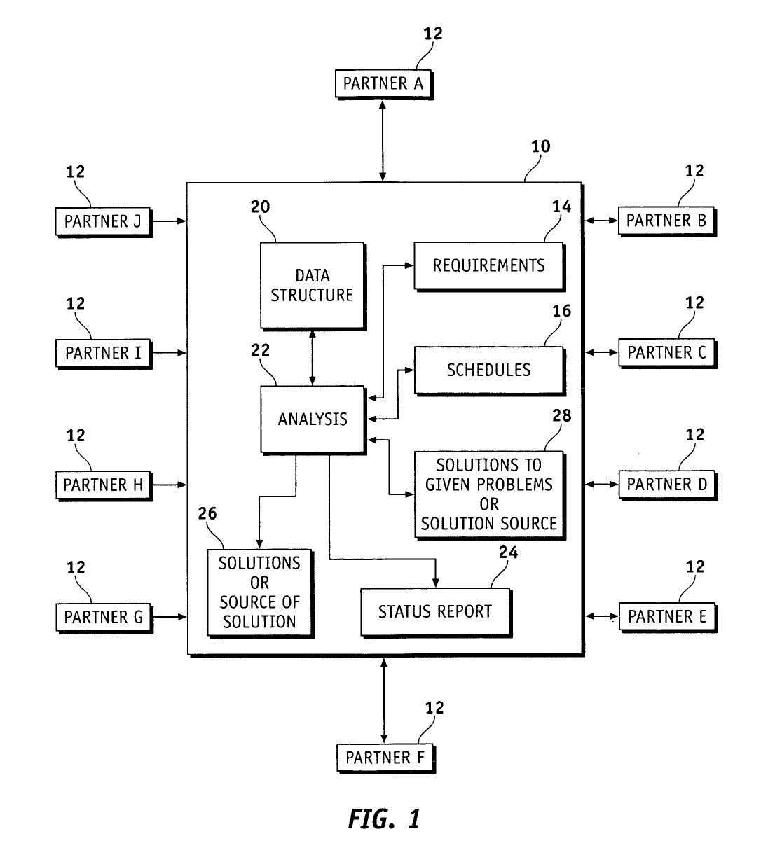

FIG. 1 is a schematic representation of an engineering manufacturing analysis system 10 (“EMAS”). The EMAS system 10 connects a number of partners 12 which are working on a same project. Each partner 12 is responsible for a portion of the project and can have multiple suppliers, manufacturers, or subcontractors. In addition, each partner 12 has its own design and manufacturing system which can be different than the design and manufacturing systems used by other partners 12. Further more, the design and manufacturing systems of each partner is located at a different site and they are all isolated from each other. The EMAS system 10 is a central system to connect all the different partners to each other only for the purpose of status sharing. The partners do not normally access each others design and manufacturing systems (Although any level of data sharing can be established or restricted as needed).

The EMAS system 10 receives program requirements 14 which are related to the tasks that partners are assigned to do (e.g., building a truck). Each requirement can contain more details related to the subtasks of each partner (e.g., doors or wheels). In addition, the EMAS system 10 receives the master schedule 16 of the project as well as all the detailed schedules related to the tasks that partners are assigned to accomplish.

The partners 12 are capable of providing status information to the EMAS system and receive information related to the impact of their status on the schedule of the other partners as well as the information on the current status of the other partners. Once the EMAS system 10 receives status from each partner 12, it associates a metadata of the status to a node on a relationship network 20. Then, the analysis block 22 analyzes the status against the relevant requirement 14 and assigns a readiness level to the status.

Depending on the project, different levels of readiness can be defined and stored in the EMAS system to be used during status analysis. For example, different readiness levels such as 100% ready, 90% ready, or different colors, or any other symbol appropriate for the project can be utilized to indicate the readiness level of each status from each partner 12. Then the EMAS system 10 creates status reports 24 showing the readiness status of different partners and makes it available to all partners 12.

Once the level of readiness of each partner 12 is identified, if the status is not 100% ready, then the EMAS system uses the associated requirements to identify the cause of delay. Depending on the identified cause, the analysis block 22 refers a list 28 to recommend a solution 26 or a source that might have a solution to the problem. In addition, during the analysis, the EMAS system 10 identifies the impact of each less than 100% ready status on the schedule of the other partners. It should be noted that the requirements 14, schedules 16, and the list 28 of the solutions/sources of solutions may be stored within or outside of the EMAS system 10.

Referring to FIG. 2, there is shown a diagram that depicts an example of a relationship network 20 that may be maintained by EMAS system 10 of FIG. 1. FIG. 2 is a conceptual diagram that is intended to assist in the following description of relationships and simply depicts a network with node intersection points for visualization purposes only and should not be confused with memory locations. An embodiment of EMAS system 10 may utilize configurations that are different and more complex than that shown in FIG. 2. Thus, although FIG. 2 depicts relationship network 20 in three dimensions, a practical implementation may utilize a relationship network having more or less than three dimensions. Multiple dimensions may be desirable to enable complex and sophisticated cross referencing and cross mapping of information.

Relationship network 20 includes a plurality of nodes, which are depicted as blocks or cells in FIG. 2. In this simplistic view, each node is addressable through a plurality of address elements corresponding to different information types. In the example shown in FIG. 2, the information types are identified by three axes: products; schedule; and partners or group members. In an embodiment of system 10 of FIG. 1, however, each node may be identified and addressed by any number of information types. The three axes identified in FIG. 2 are not intended to limit the scope or application of an embodiment of the invention in any way; these axes are shown to aid in the description of system 10.

In this example, the product axis of relationship network 20 represents all products specified for a given program. For example, if the program is a fleet of transportation vehicles, then each row of blocks along the product axis may identify a different vehicle, e.g., different car models, different boat models, different motorcycle models, different truck models, etc.

In this example, the schedule axis may represent a timeline broken down at any desired resolution, e.g., by hour, day, week, month, or year. In practical embodiments, the schedule axis may also indicate development milestone or phase dates. In this regard, the example embodiment described below tracks milestone dates that correspond to different EMRLs.

In this example, the group member axis of relationship network 20 represents different entities that are participating in the program. In practice, the group member axis may identify the different partners in the program, such as company A, company B, and company C. Relationship network 20 is configured to link the various group member relationships as necessary to support the functionality of system 10. For example, if a point along the product axis indicates an airplane, that airplane may have any number of linked partners along the vertical partners axis (different partners may be responsible for different assemblies of the airplane).

In the example of FIG. 2, one node 32 of relationship network 20 corresponds to Partner J, Product 1, and Schedule T10, another node 34 corresponds to Partner J, Product 5, and Schedule T3, and yet another node 36 corresponds to Partner C, Product 7, and Schedule T10. Each of the remaining nodes is similarly indexed relative to the three axes depicted in FIG. 2.

The EMAS system 10 receives a status of a given product from each partner in the form of a metadata and associates the metadata to a node on the relationship network 20. In this example embodiment, the metadata may indicate, describe, or characterize status information of a partner. In other words, the metadata associated to a node on of a relationship network 20 provides a link to the status information and the artifact of a partner which are located at the design and manufacturing system of that partner. The artifacts are the documents supporting the status information. It should be noted that since each partner is not involved with all the products, there are nodes on the relationship network which may not define a relationship and associated metadata to that partner etc.

In operation, any update on partner J's product P1 during schedule phase T10 will be kept in the EMAS system 10 as a metadata associated to node 32, any update on partner J's Product P5 during schedule phase T3 will be kept in the EMAS system 10 as a metadata associated to node 34, and any update on partner C's product P7 during schedule phase T10 will be kept in the EMAS system 10 as a metadata associated to node 36. It should be noted that the schedule updating may be accomplished in an automated manner. If a status information is updated in a partner's design and manufacturing system, a link automatically updates the metadata in the EMAS system 10. The relationship network 20 provides a top level relationship between the partners' products, and the schedules. However, the project may require more detail. For example, if product P1 of partner J is a truck, the project may require status information on the wheels, doors, engines of the truck and also the status information on the suppliers or manufacturers of these components.

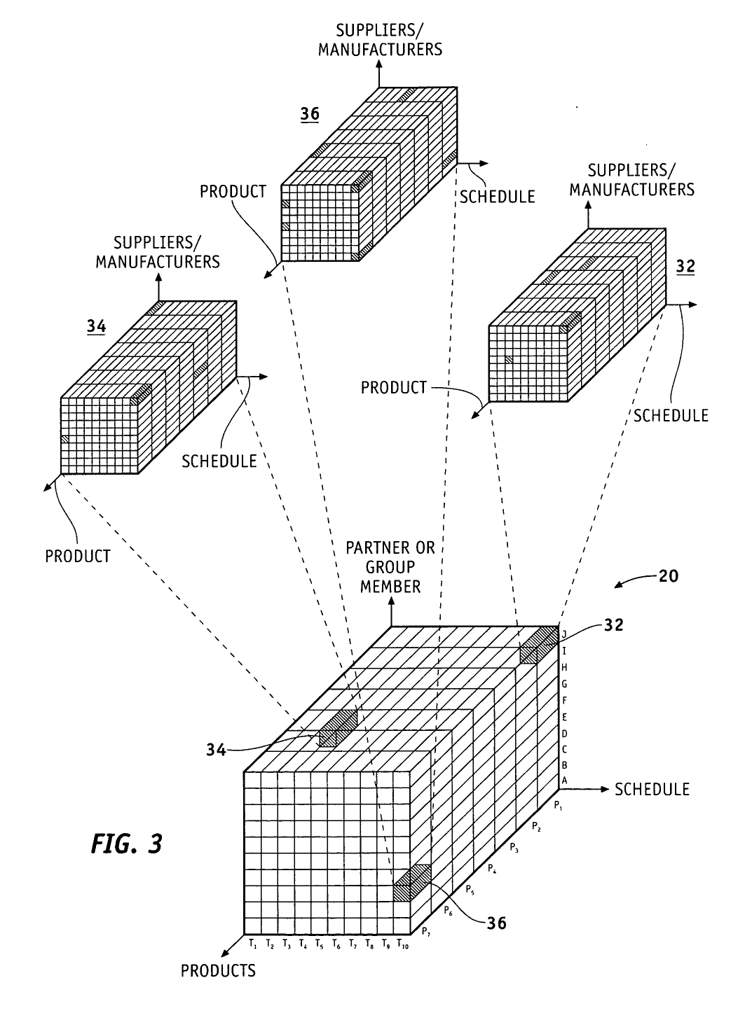

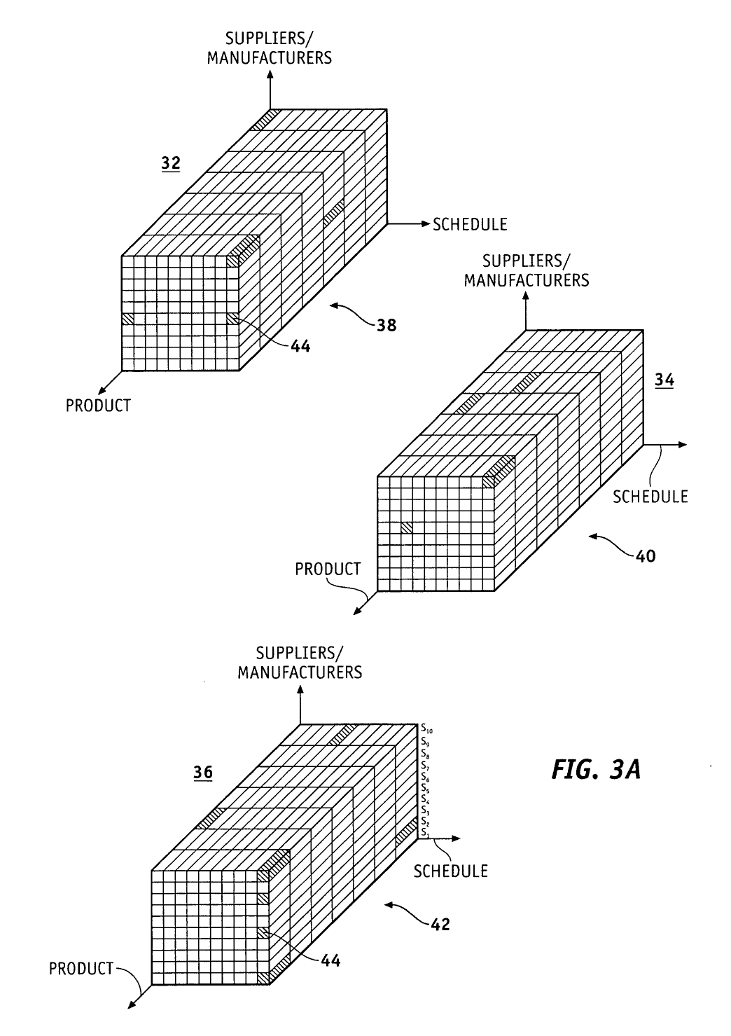

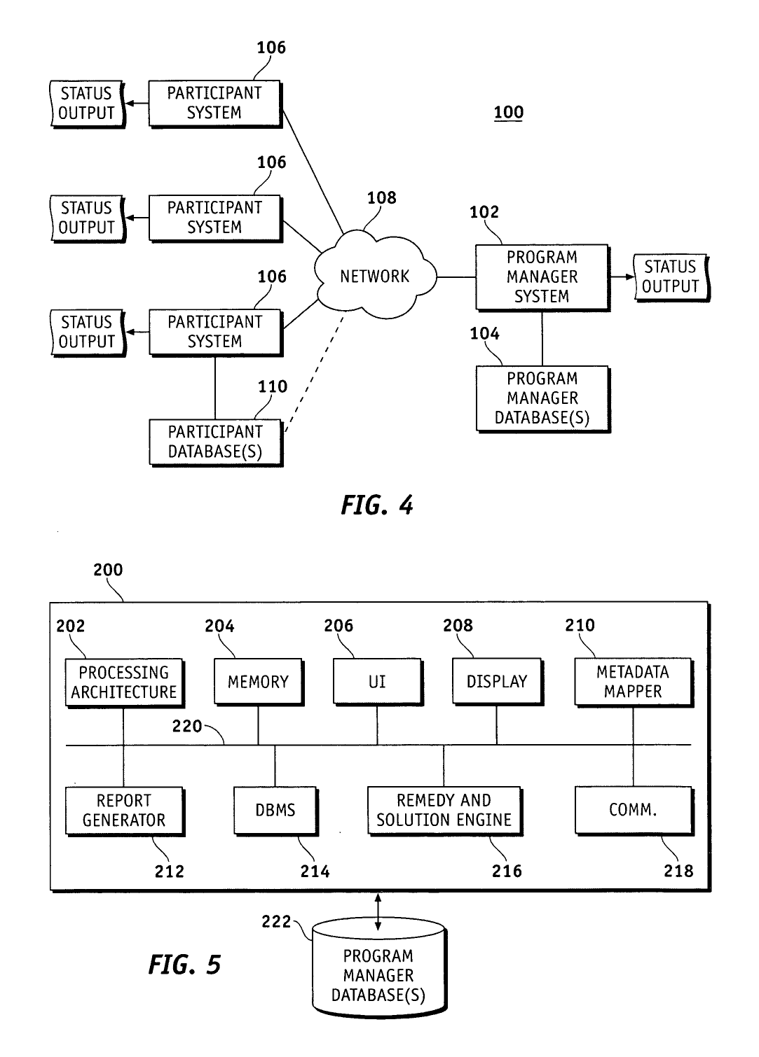

In order to provide more detail, each node in relationship network 20, may be configured as a relationship network by itself to provide further level of details on the status of the partners, products, and schedule. In this regard, FIG. 3 depicts nodes 32, 34, and 36 of FIG. 2 in more detail. The general characteristics and properties of these individual relationship networks are similar to that described above for relationship network 20. Referring to FIG. 4, there is shown a larger view of relationship networks 32, 34, and 36. Briefly, each node depicted in FIG. 4 is addressable through a plurality of address elements corresponding to different information types, and each addressable location in FIG. 4 may have its own set of metadata associated therewith.

Node 32 may be configured as a relationship network 38 that is addressable through the following address elements: products including components; partners including suppliers and manufacturers; and detailed schedules. In this example, since the node 32 of FIG. 2 represents Product 1 of partner J at schedule phase T10, the relationship network 38 also represents Product 1 of partner J at schedule phase T10. However, the product axis may identify database entries for all of the components related to the entire project. In other words, the components axis can represent all the components even if such cross referenced components are not specifically related to Partner J, Product 1, and Schedule T10; such cross referencing may be useful because a single component may actually evidence satisfaction of a requirement for multiple products or parts. In the same manner, the partner axis and the schedule axis represent all the components and the requirements for the entire project. It should be noted that since there are database entries on the axis of the relationship network 38 which may not be used in product 1 of the partner J, some nodes will not define a relationship and do not have an associated metadata.

Nodes 34 and 36 of FIG. 2 may also be configured as relationship networks 40 and 42 respectively and they will be addressable through products including components, partners including suppliers and the manufacturers, and detailed schedules of the entire project. It should be noted that when each one of the nodes of the relationship network 20 of FIG. 2 is configured as another relationship network, they all use the same axis. As a result, relationship networks 38, 40, and 42 all use the same axes with identical details.

One skilled in the art can appreciate that if further level of detail is required by a project, each location of the relationship networks 38, 40, and 42 can be configured as a relationship network to provide a deeper level of details. Regardless of the number of levels created for the representation of the details, the top level relationship network 20 and its sublevel relationship networks 38, 40, and 42 create a relationship between different elements of a project. For example, in the above examples, the relationship network 20 and its first sublevel relationship networks 38, 40, and 42 create a network between the all the partners, products, schedule, and their status.

Referring back to FIG. 1, the data EMAS system 10 receives all the requirements 14, schedules 16 of the entire project. Requirements are assigned to the nodes which have associated metadata. Therefore, for each level of relationship network, there is a set of requirements for the nodes on the networks of that specific level. For each level of relationship network, there is a set of Every time a metadata associated with the top level or the sublevel relationship networks is updated, the analysis block 22 utilizes the updated metadata to collect information on the updated status from the partner's system. Then the analysis block 22 identifies the requirements 14 associated with the updated status, analyzes the status against the requirements 14, and assigns a readiness level to the updated status. Then, the analysis block 22 can look through the relationship network 20 to find out the impact of the newly updated status on the other parts of the project.

For example, referring to FIG. 2, if the truck example of partner J, needs to use steering wheels, the analysis block looks through the relationship network 20 to see who else needs to use steering wheels and for example, identifies that partner C who builds boats also needs steering wheels at the same time T10 that partner J needs them. Referring to both FIGS. 2 and 4, the analysis block 20 checks the relationship networks 32 and 36 and identifies that supplier S5 is the supplier of the steering wheels for both partners J and C. The analysis block 20 also checks the metadata of supplier S5, which is associated with 44 of both relationship networks 38 and 42, and identifies that supplier S5 does not have enough steering wheels for both partners J and C. Then, the analysis block 20 creates a report on the impact of the updated status and generates a report showing that due to the shortage of the steering wheels, either the trucks or the boats, or both will be delayed.

The analysis block 20 may also check the relationship networks 20, 38, 40, and 42 to find a different supplier such as supplier S8 and through the metadata of the supplier S8 identifies if the new supplier has enough supply of steering wheels. With a newly identified supplier S8, the analysis block 20 generates a supplier recommendation for partners J and C to prevent the delay in the production of the trucks and the boat.

In addition, if the analysis block 20 does not find a solution through the relationship networks 20, 38, 40, and 42, then it will check the solutions/Solution source list 28 to find an alternative solution or a possible source of information to solve the problem.

In the above example, if the project requires to identify the impact of delay due to for example shortage of materials, then the nodes of relationship networks 38, 40, and 42 can also be configured as second sublevel relationship networks to provide relationships between suppliers and materials which are used in the products represented in the first sublevel relationship networks 38, 40, and 42.

One skilled in the art should appreciate that the EMAS system 10 can also be used for large projects other than design and manufacturing. For example, projects related to multiple services, products, and entities such as hospitals, auto repair shops, biological labs, and universities.

The metadata associated with an artifact may include, without limitation: a link or pointer to the database location for the artifact (e.g., a URL); a time/date stamp for the artifact; an identification of the source or creator of the artifact; an identification of the partner responsible for the uploading of the artifact; an identification of the project items to which the artifact applies; an identification of the project requirements to which the artifact applies; or the like. In example embodiments, the metadata associated with an artifact includes status data for that artifact, and the system is suitably configured to automatically update the artifact metadata in response to a change in the artifact file.

The parts axis in FIG. 3 represents the different individual parts (or other category of items) that are associated with Partner J, Product 1, and Schedule T10. In practice, the same part—such as a steering wheel—may be used in two different products, for example, a car and a boat. Accordingly, data structure 50 may be configured such that the metadata for the steering wheel part associates the steering wheel to the car, the boat, and any other product that includes that steering wheel. In this regard, data structure 58 (and any of the data structures described herein) may identify all of the possible address elements handled by the system 10, whether or not those possible address elements are applicable or active for the currently addressed location. This arrangement will enable system 10 to maintain any possible cross link or cross reference among the different information types.

The requirements axis in FIG. 3 represents the different project requirements that are to be satisfied according to the schedule. Requirements are linked to artifacts, which evidence at least partial satisfaction of requirements. Thus, data structure 58 includes an addressable location 60, which may represent Part 10, Artifact 1, and Requirement 1, where Artifact 1 evidences at least partial satisfaction of Requirement 1 for Part 10. Similarly, data structure 58 includes an addressable location 62, which may represent Part 6, Artifact 3, and Requirement 10, where Artifact 3 evidences at least partial satisfaction of Requirement 10 for Part 6. Data structure 58 also includes an addressable location 64, which may represent Part 10, Artifact 7, and Requirement 10, where Artifact 7 evidences at least partial satisfaction of Requirement 10 for Part 10. In practice, Partner J, Product 1, and Schedule T10 may be associated with more than just three related parts, which would be addressed in a similar manner.

In this example, addressable location 54 corresponds to a data structure 66 having the same three axes described above for data structure 68. Here, data structure 66, which corresponds to Partner J, Product 5, and Schedule T3 (see FIG. 2), identifies four related parts. Of course, Partner J, Product 5, and Schedule T3 may be linked to more than just four parts, which would be addressed in a similar manner. Notably, data structure 66 includes an addressable location 68, which may represent Part 10, Artifact 7, and Requirement 10 as described above in connection with data structure 58. This commonality illustrates how two different products (Product 1 from addressable location 52 and Product 5 from addressable location 54) may be mapped to the same part, artifact, and requirement. Such commonality may also occur in connection with any combination of information types, at any level of the overall data structure, and any number of dimensions of the overall data structure.

Addressable location 56 corresponds to a data structure 70 that is addressable through the following address elements: status; solutions; and subassemblies. In this example, the status axis may identify the current status level for an associated product, part, subsystem, or other category of project item. As described below, the status level may be a color coding that represents a producibility measurement. The solutions axis may identify solutions and/or remedies to problems or issues detected by system 10. In this regard, the solutions may be mapped to the different requirements using metadata. The subassemblies axis represents different subassemblies that may be found in the respective product. Generally, data structure 70 may be configured to support cross referencing and cross mapping as described above.

Data structure 70 is one example of an alternate “second level” data structure that may be associated with one cell of data structure 50 (see FIG. 2). In practice, data structures at this second level may be addressable using any number of axes, and such axes may identify information types other than that depicted in FIG. 3. As described above in connection with FIG. 2, each of the data structures at this second level may be more complex than a three dimensional grid. Furthermore, each individual cell in data structures 58, 66, and 70 may include a “third level” data structure that establishes yet further data relationships using the metadata.

FIG. 4 is a schematic representation of a network-deployed automated EMAS 100 configured in accordance with an example embodiment of the invention. Referring to FIG. 1, system 10 may be incorporated into EMAS 100. Of course, other practical deployments of EMAS 100 are possible, and the system shown in FIG. 4 is not intended to limit the application or scope of an embodiment of the invention. EMAS 100 generally includes a program manager system 102, one or more program manager databases 104, and any number of participant systems 106. Although FIG. 4 depicts only one program manager system 102 and only three participant systems 106, an embodiment of the invention may include any number of program manager systems and any number of participant systems. These systems may be realized as any suitably configured computing device, system, or component, such as, without limitation, personal computers, portable computers, personal digital assistants, smart phones, or the like. EMAS 100 includes a suitable network 108, which may include any known data communication, telecommunication, wireless, wired/cabled, or other technology. For example, network 108 may include or be realized as a LAN, a WAN, the Internet, a cellular telecommunication network, or the like. In this example, one of the participant systems 106 is coupled to one or more participant databases 110, which may also be directly coupled to network 108 (represented by the dashed line in FIG. 4).

In practice, program manager system 102 maintains the processing intelligence and software applications associated with EMAS 100, and program manager system 102 is the primary management and control terminal for EMAS 100. Program manager database 104 is suitably configured to store artifacts (e.g., electronic files) that may be uploaded to EMAS 100 via participant systems 106 and/or via program manager system 102. Participant database 110 is also suitably configured to store such artifacts. EMAS 100 may leverage participant database 110 if needed. For example, a given participant may decide to host its own artifacts and only provide links (e.g., URLs) to access those artifacts, which may reside on participant database 110. Program manager database 104 and/or participant database 110 may also be configured to maintain parts lists for projects handled by EMAS 100.

The invention relates to a collaborative data relationship and management system that links any number of different data types and categories together in a meaningful manner that enables users of the system to analyze the data in a contextual manner that is appropriate to the given program or project. In this regard, the data handled by the system is interrelated according to the context of the program or project. For example, in a manufacturing context, the different data types may be categorized in terms of vendors, suppliers, manufacturing schedules, project requirements, producibility criteria, products, subassemblies, parts, or the like.

The system utilizes metadata, metadata mapping, and data relationship techniques that create the relationships between the different data types and between specific pieces of data. Moreover, the metadata may point to artifact data (e.g., electronic documents or files) stored at one or more databases, where the artifact data evidences satisfaction of certain requirements, criteria, or characteristics associated with one or more of the information types. Although not limited to any particular implementation, the system is suitable for use in connection with an EMAS as described herein.

An EMAS configured in accordance with an example embodiment of the invention provides tools that associate EMRLs with each requirement and deliverable in a project. This associated data can be updated in real time throughout the project lifecycle by one or more parties responsible for the design, development, and/or manufacture of the individual parts, components, assemblies, or elements utilized in the project. The data is maintained in one or more databases, and the responsible parties may be granted access to the database. The EMAS can collect and process the data to create reports that indicate a current view of the status and progress of the program. The EMAS provides an automated way to view project status, e.g., via predictive health indicators, reports, exit criteria, or the like. Predictive health indicators are trend data with risk probability analysis that looks at the current data in reference to the history/frequency of data entering the system, establishes trend data by criteria, status, or requirement, and calculates the probability of successfully completing the tasks within the calendar period of the phase being assessed. Exit criteria is the grouping of requirements within a program phase that should be completed prior to a specific program date or milestone, i.e., EMRL level 1 may constitute a selection of 33 requirements that are mapped to a particular phase; this of course could be any mapped collection of requirements to a particular program date or milestone.

In addition, the EMAS is suitably configured to determine the lowest level cause or systemic cause of problems that may impact the success of the project. Lowest level cause is initiating cause or source of the risk. For example, if there is a negative indicator under the criteria of Design Producibility, the analyst could drill down and identify that this risk is concentrated under the metric of Form, Fit and Function, and further drill down and find that this negative indicator is associated to a specific assembly part number and one specific part within that assembly. For example, if a particular circuit card assembly currently does not fit or meet the functional requirement of the design, the lowest level cause can be identified. In practice, the detection of problems early in the lifecycle of a project can significantly impact the overall success of the project; early detection of problems often leads to corrective action taken at the early design stage, thus enhancing the producibility.

The concept of producibility is typically associated with a number of measurable characteristics, including, without limitation: specified materials; simplicity of design; interchangeability of parts or components; commonality; flexibility in production alternatives; tolerance requirements; clarity and simplicity of the technical data package; design stability; and process controls. In this regard, “specified materials” are those materials from which a specific product is made, e.g., aluminum, steel, composites, etc. “Commonality” refers to items that can support multiple end products. “Clarity and simplicity of the technical data package” is an indication of whether unambiguous information defines the end product, e.g., the build-to, buy-to, and support-to plans. “Design stability” means that minimal to no design changes are necessary after major design reviews.

Briefly, the approach described herein is based upon a sound set of producibility criteria common among contemporary manufacturing industries. The EMAS integrates the criteria to: (1) major program milestones, i.e., the maturity of engineering and manufacturing processes at significant program milestones; (2) enable technology solutions, e.g., those based upon EMRL assessment and identification of engineering/manufacturing remedies that can be used to retire and mitigate program risk; (3) health indicator reporting, e.g., metrics reporting production maturity, progress, and trends made at multiple levels of a product structure isolating where specific and systemic production risks reside; (4) production risk prioritization, i.e., software conducting analyses using specific criteria, program milestones, level of process maturity, type of production risk identified, recommended solution, and determination of what risk carries the greatest impact to the program from highest to least. The EMAS leverages a networked computer environment in which data is stored, updated, reported, and used for continuous improvement among any number of partners, vendors, designers, manufacturers, or other participants in the project.

The technical merit of an example EMAS is based on its ability to evaluate the maturity of a participant's engineering and manufacturing systems and processes against a set of criteria that is standard across industry. The EMAS takes data supplied by the participant and measures such data against major program milestones to determine the maturity of that participant at a given time in the program. The system considers the participant's use of certain enabling technologies as solutions that can be used to identify, mitigate, and retire production and manufacturing risk. One benefit of the example EMAS is its ability to assess the list of criteria against the artifacts that the participant provides (via uploading to the database). This gives the participant and the program management team a way to score the participant and develop mitigation plans long before the actual program review meetings. The EMAS described herein eliminates the surprises that are common at program reviews and allows the participant and the program management team to identify technical and process weaknesses early. Such early identification can lead to corrective action prior to the milestone review meetings. The EMAS can be configured as a comprehensive software application that measures the engineering and manufacturing readiness and maturity in an automated and systematic way, producing a scorecard rating against major program milestones.

FIG. 1 is a schematic representation of a collaborative data relationship and management system 10 configured in accordance with an example embodiment of the invention. Generally, system 10 is capable of handling data associated with any number of different information types. In FIG. 1, the information types correspond to project or program schedules 12, project requirements that are organized in any number of requirement groups 14, members of a group or partners 16, and project items that are associated with the different partners 16. Although not depicted in FIG. 1, the information types may also include, without limitation: artifacts; criteria; solutions or remedies; EMRLs; status; milestone levels; any information type, category, or set described herein; or the like. As used herein, a project item may be a system, a subsystem, an assembly, a subassembly, a component, a part, a feature, a function, a deliverable, any definable aspect of the program or project, or any combination thereof. As described in more detail below, system 10 may generate, maintain, and/or update metadata related to the information types.

The schedules 12 may indicate development milestones, deadlines, times, or dates for the particular project or program. In practice, the program itself may have a master schedule that is fed into system 10. In addition, an individual partner 16 may have its own internal schedule, and such internal schedules may also be loaded into system 10. As described in more detail below, system 10 may generate, maintain, and/or update metadata related to schedules 12.

Each requirements group 14 includes at least one requirement that is applicable to at least one data type handled by system 10, and system 10 may handle any number of requirements groups 14. For example, a given requirement may apply to a particular partner 16, to a group of partners 16, to individual products or items associated with a partner 16, etc. FIG. 1 depicts a group of requirements under requirements group 14a, a group of requirements under requirements group 14b, and so on. In an embodiment of system 10, however, the requirements groups 14 need not be mutually exclusive and any given requirement may be a member of one or more requirements groups 14. The requirements can be fed into system 10 as needed, and categorized or grouped to suit the needs of the particular application or program. For example, as described below, a group of individual requirements may be associated with one metric, a group of metrics may be associated with one criteria, and a group of criteria may be associated with one development milestone level, such as an EMRL. Thus, requirements group 14a may correspond to one metric, requirements group 14b may correspond to one criteria, and requirements group 14c may simply be a listing of individual requirements. As described below, system 10 may generate, maintain, and/or update metadata related to the individual requirements and/or metadata related to any hierarchical grouping, categorization, or association of individual requirements.

The system 10 is able to handle any number of partners 16, which may be grouped or categorized in any suitable manner. In this example, partners 16 are able to provide data to system 10 and are able to receive data, such as reports, from system 10. For example, partners 16 can pull requirements and schedules 12 from system 10, and provide status and artifacts corresponding to the requirements to system 10. Partners 16 may also provide internal schedules to system 10.

Partners 16 may be organized such that lower level entities are linked to higher level entities (akin to a general contractor and subcontractors). Alternatively, all of the partners 16 may be designated as peers, with no hierarchical organization whatsoever. Moreover, a higher level partner, such as a general contractor for a building, may also serve as a lower level partner linked to itself (for example, a subcontractor responsible for the electrical wiring of the building). In this example, each partner 16 is responsible for one or more items in the project, where an item may be a physical or intangible system, subsystem, assembly, subassembly, component, part, piece, product, application, feature, or the like. For example, an item may be a product such as a vehicle, and that product may be linked to a number of other items (assemblies, subsystems, etc.) that are used in the vehicle, such as tires, an engine, seats, and fasteners. Likewise, the assemblies in the vehicle may include any number of parts or components (e.g., the engine may include hundreds of individual parts). System 10 is suitably configured to maintain linked relationships between items and different levels of items as necessary. In practice, the different items are populated into system 10 and are linked to the responsible partners using metadata and the techniques described herein. In this regard, system 10 may generate, maintain, and/or update metadata related to the partners 16 and/or metadata related to any hierarchical grouping, categorization, or association of partners 16. Moreover, system 10 may generate, maintain, and/or update metadata related to the items assigned to the partners 16 and/or metadata related to any hierarchical grouping, categorization, or association of such items.

In operation, system 10 may generate reports 18, such as status reports related to the different data types. FIG. 1 depicts a double ended arrow leading to reports 18 because system 10 may also be configured to receive reports and status information from partners 16 and/or other outside sources. Incoming reports may be utilized by system 10 to update the current project status, to update metadata, or the like. As described in more detail below, system 10 may be configured to generate solutions/remedies 20 in response to the detection of potential problems or issues related to the specific context of the particular program or project. In this regard, system 10 may identify a problem along with a recommended solution to the problem. Alternatively (or additionally), system 10 may be configured to identify a problem along with a recommended solution source. The solution source may be an external resource, enabler, or person trained to resolve the problem. In this example, solutions/remedies may be treated like any other information type, solutions/remedies can be linked or otherwise associated with one or more other information types, and system 10 may generate, maintain, and/or update metadata related to the solutions/remedies.

FIG. 2 is a diagram that depicts an example data structure 50 that may be maintained by system 10 shown in FIG. 1. Data structure 50 may reside in one or more databases throughout system 10. In the example embodiment, metadata handled by system 10 is maintained in a central database. FIG. 2 is a conceptual diagram that is intended to assist in the following description of data structure 50, an embodiment of system 10 may utilize structures that are different and more complex than that shown in FIG. 2. Thus, although FIG. 2 depicts data structure 50 in three dimensions, a practical implementation may utilize a data structure having more or less than three dimensions. Multiple dimensions may be desirable to enable complex and sophisticated cross referencing and cross mapping of information.

FIG. 5 is a schematic representation of an example program manager system 200 suitable for use in EMAS 100. As mentioned above, system 200 may be realized in a conventional computing platform and conventional aspects of such computing platforms will not be described in detail in the context of system 200. System 200 generally includes a processing architecture 202, a suitable amount of memory 204, user interface features 206, a display element 208, a metadata mapper 210, a report generator 212, a database management system (“DBMS”) 214, a remedy and solution engine 216, and a communication module 218. The elements of system 200 may be coupled together via a bus 220 or any suitable interconnection architecture.

Those of skill in the art will understand that the various illustrative blocks, modules, circuits, and processing logic described in connection with program manager system 200 (and other devices, elements, and components disclosed here) may be implemented in hardware, computer software, firmware, or any combination of these. To clearly illustrate this interchangeability and compatibility of hardware, firmware, and software, various illustrative components, blocks, modules, circuits, and processing steps may be described generally in terms of their functionality. Whether such functionality is implemented as hardware, firmware, or software depends upon the particular application and design constraints imposed on the embodiment. Those familiar with the concepts described here may implement such functionality in a suitable manner for each particular application, but such implementation decisions should not be interpreted as causing a departure from the scope of the present invention.

Processing architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

In practice, processing architecture 202 may be suitably configured to control, manage, oversee, or perform the various tasks, processes, and methods described herein. Moreover, processing architecture 202 may include, cooperate with, and/or influence other logical components of program manager system 200, such as metadata mapper 210, report generator 212, DBMS 214, remedy and solution engine 216, or communication module 218. For example, processing architecture 202 is preferably configured to analyze metadata for addressable locations in data structures maintained by EMAS 100, where such analysis is performed against a respective set of requirements.

Memory 204 may be realized as RAM memory, flash memory, EPROM memory, EEPROM memory, registers, a hard disk, a removable disk, a CD-ROM, or any other form of storage medium known in the art. In this regard, memory 204 can be coupled to processing architecture 202 such that processing architecture 202 can read information from, and write information to, memory 204. In the alternative, memory 204 may be integral to processing architecture 202. As an example, processing architecture 202 and memory 204 may reside in an ASIC. In this example, memory 204 may be utilized to store parts lists for projects, metadata, artifact links, artifact files, options/preferences data for EMAS 100, logical requirements structures for projects and programs being managed by EMAS 100, reports, and any data or information received, transmitted, saved, generated, analyzed, or otherwise handled by program manager system 200 and/or EMAS 100. Memory may be configured to store data structures as described above in connection with FIG. 2 and FIG. 3.

User interface features 206 enable the user to control the operation of program manager system 200. User interface features 206 may include, without limitation: a keypad, a keyboard, buttons, switches, knobs, a touchpad, a joystick, a pointing device, a virtual writing tablet, or any device, component, or function that enables the user to select options, input information, or otherwise control the operation of system 200.

Display element 208 is suitably configured to enable program manager system 200 display user interface screens, status reports, and other information necessary to support the operation of EMAS 100. In practice, display element 208 may be a computer monitor that leverages known display technologies such as, for example, CRT, LCD, or plasma technology.

Metadata mapper 210 represents a logical element that functions to establish relationships between data items handled by EMAS 100. For example, metadata mapper 210 may process metadata that indicates, describes, or modifies: status information; requirements; artifacts; participants; parts; projects; milestone levels; any of the information types described above in connection with FIGS. 1-3; or the like. EMAS 100 may consult metadata mapper 210 as needed to obtain relationships and links between data items. In this regard, metadata mapper 210 may be useful during status or health report generation, when linking artifacts to parts and requirements, and when linking current status information to parts and requirements.

Report generator 212 is suitably configured to generate project health reports (in a variety of formats), project status reports (in a variety of formats), and/or any other reports which may be requested by the project manager or by the participants of EMAS 100. Such reports may indicate or provide a result in response to analysis of metadata maintained by EMAS 100. The result may be formatted in an appropriate manner based on the context of the program, e.g., a status level assigned to the metadata, an identification of a problem, a recommended solution to the problem, a recommended solution source, or the like. Report generator 212 may cooperate with processing architecture 202, metadata mapper 210, and possibly other components of program manager system 200 to process the relevant data and information, format reports, and provide status outputs in a desired manner. In example embodiments, the project health reports are influenced by the ongoing status information and data that is entered into EMAS 100. FIG. 4 depicts such status outputs generated by program manager system 102 and participant systems 106. Such status outputs may be generated electronically and/or printed as hard copy reports.

DBMS 214 may be realized as any conventional database management system. In this regard, DBMS 214 may include one or more applications that enables program manager system 200 to receive, store, modify, manipulate, and retrieve information from a program manager database 222 and/or from memory 204. In practice, EMAS 100 may be responsible for tracking thousands of parts, and more than one hundred requirements per part, for multiple project milestone levels. Moreover, each part-requirement combination may have multiple potential status states. Consequently, it may be desirable for a practical EMAS 100 to employ an efficient and reliable DBMS 214.

Remedy and solution engine 216 represents processing logic that is suitably configured to perform an automated analysis of project health at any given point in time. In practice, remedy and solution engine 216 may respond to metadata that links solutions and remedies to requirements and the associated status of such requirements. Remedy and solution engine 216 is preferably configured with the intelligence to be able to identify potential problems and/or issues that may adversely affect producibility of the particular product, component, system, or technology. In the example embodiment, remedy and solution engine 216 is programmed to recognize individualized or systemic trends, patterns, or characteristics that might negatively impact producibility. In response to the detection of such problems, remedy and solution engine 216 generates a recommended remedy, solution, approach, or action plan that addresses the potential problems and/or issues. The suggestion may be conveyed in a status or health report or in an automatically generated notification to a participant or to the program manager. In this manner, remedy and solution engine 216 can prevent future problems by giving the participants a chance to take corrective action (such as design revision) soon after a problem is detected.

An embodiment of program manager system 200 may employ any number of communication modules 218 that are suitably configured to support data communication between system 200 and other computing devices or terminals, such as participant systems. For example, communication module 218 may be configured to support data communication between system 200 and participant systems 106 via network 108 (see FIG. 4). Depending upon the particular implementation, communication module 218 may be configured to support unidirectional communication from participant systems to system 200, unidirectional communication from system 200 to participant systems, or bidirectional communication between system 200 and participant systems. Moreover, depending upon the particular implementation, communication module 218 may be configured to support wireless data communication, wired/cabled data communication, or both. Thus, an example embodiment of communication module 218 may support one or more of the following data communication protocols, techniques, or methodologies, without limitation: RF; IrDA (infrared); Bluetooth; ZigBee (and other variants of the IEEE 802.15 protocol); IEEE 802.11 (any variation); spread spectrum; frequency hopping; cellular/wireless/cordless telecommunication protocols; satellite data communication protocols; GPRS; Ethernet; USB; IEEE 1394 (Firewire); and proprietary data communication protocols.

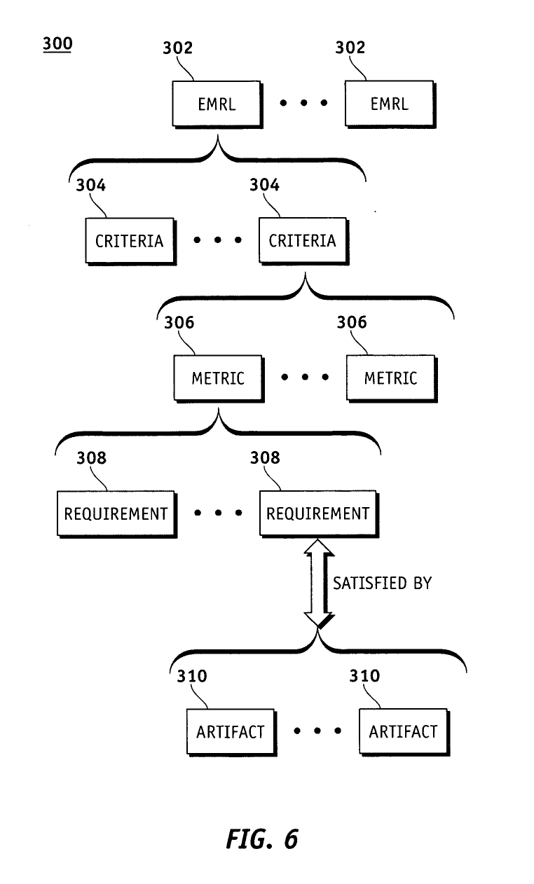

As mentioned above, an EMAS configured in accordance with an example embodiment of the invention can manage a project having defined milestone levels corresponding to different developmental stages of the project. In this regard, FIG. 6 is an example logical requirements structure 300 that may be utilized by an EMAS, such as EMAS 100. Logical requirements structure 300 represents various relationships and example categories that might be utilized in an embodiment of the invention. Logical requirements structure 300 also identifies different information types handled by this embodiment of the invention.

The development or manufacturing lifecycle of a project, program, business deployment, or technology can be earmarked by one or development milestone levels. The following description focuses on an example embodiment of the invention that is configured to process different ERMLs 302 corresponding to different milestone levels or developmental stages during the lifecycle of a program. Embodiments of the invention are not so limited, however, and such embodiments may be modified for equivalent operation in the context of any desired engineering, manufacturing, technology, or any other scheme. For example, an alternate embodiment of the invention may be configured for use in connection with technology readiness levels (“TRLs”), which may be utilized for the production of electronic systems, circuits, software applications, or the like.

As an example, EMRL 0 may be characterized as follows: the system, component, or item is in the concept phase, and ready to enter into concept validation in a laboratory environment or initial relevant engineering application (bread board or brass board development) phase. EMRL 0 is the lowest level of production readiness. Technology maturity is between TRL levels 1 through 3. At this point, few if any of the requirements have been finalized and engineering concepts are being validated. Physical and functional component interfaces may not be fully defined. Producibility philosophies and approaches are being considered as part of the design process. Points of contacts and subject matter experts for processes, materials, tooling, special test equipment, and potential manufacturing technology initiatives have been identified and are integrated into the design team.

As an example, EMRL 1 may be characterized as follows: system, component, or item validation in a laboratory environment or initial relevant engineering application (bread board or brass board development), and ready to enter into a concept technology demonstration phase. EMRL 1 is a relatively low level of production readiness. Technologies must have matured to at least TRL 4. At this point, all requirements have not been finalized and there may be significant engineering and/or design changes. Component physical and functional interfaces have not been completely defined. Producibility has been considered as part of the design process. Processes, materials, tooling, and special test equipment (“STE”) are being considered. Potential manufacturing technology initiatives have been identified. Industrial Base (“IB”) has been surveyed for similar technologies.

As an example, EMRL 2 may be characterized as follows: system, component, or item in prototype demonstration beyond bread board or brass board development, and ready to enter system development and demonstration phase. Technologies must have matured to at least TRL 6. However, there are still many engineering and/or design changes and physical and functional interfaces that are not yet fully defined. Similar manufacturing processes and materials have been demonstrated. Specific trade studies have been conducted to evaluate packaging, custom components, and key characteristics to identify producibility improvements and cost reductions. Required manufacturing technology initiative efforts have been initiated. All tooling, material, and STE requirements are defined and plans are now in place to address any specific issues. IB has been established for similar components or plan developed for developing facilities.

As an example, EMRL 3 may be characterized as follows: system, component, or item has been developed and is ready for low rate initial production. Technologies must have matured to at least TRL 8. At this point engineering and/or design changes have decreased significantly. Physical and functional interfaces have been clearly defined. Cost estimates are generated to compare to cost goals. Processes, materials, tooling, and STE are proven on a pilot line. During this phase, initial production readiness assessments should be completed. Specific facilities are in place and have been validated, and production flows are defined.

As an example, EMRL 4 may be characterized as follows: system, component, or item has been previously produced or is now in production. Alternatively, the system, component, or item is in low rate initial production. Ready for full rate production. There should be no more than minimal system engineering and/or design changes. Technologies must have matured to at least TRL 9. Materials are in production and are available to meet the planned production schedule. Manufacturing processes and procedures are established and controlled in production to three-sigma or some other appropriate quality level. Tooling, STE, and facilities have been demonstrated to meet Low Rate Initial Production (“LRIP”) requirements. Cost estimates meet cost goals. Production readiness assessments are conducted as necessary.

As an example, EMRL 5 may be characterized as follows: the system, component, or item is in full rate production. This is the highest level of production readiness. There are essentially no engineering/design changes. All materials, manufacturing processes, and procedures are controlled in production to six-sigma or some other appropriate quality level in production. Design to cost goals are met. Tooling, STE, and facilities have been demonstrated to meet full rate production requirements.

Each EMRL 302 may correspond to one or more criteria 304. Generally, each criteria 304 corresponds to a different producibility category, and a given EMRL 302 may include any number of criteria 304. Although not a requirement of the invention, an example embodiment of EMAS 100 uses the following criteria 304: Design Producibility; Design to Cost; Industrial Base and Facilities; Materials; Processes; Technical; and Tooling/STE. Briefly, “Design Producibility” refers to ease of building a product repeatedly, predictably, and affordably, “Design to Cost” refers to meeting design cost targets, “Industrial Base and Facilities” refers to those suppliers and their facilities supporting the needs of the program, “Materials” refers to tangible components used to build the hardware, e.g., electrical, mechanical, electromechanical, chemical, and other items, “Processes” refers to documents that define the steps required to obtain a desired outcome, “Technical” refers to science and technology, requirements, skills, and technology maturation, and “Tooling/STE” refers to equipment required to support the physical fabrication, assembly, and integration of the product; and whether special test equipment (“STE”) may be required for product validation.

In the example embodiment, each EMRL 302 includes a plurality of criteria 304, as depicted in FIG. 6. Moreover, in the example embodiment, the same set of criteria 304 applies to each individual EMRL 302. In other words, the seven criteria 304 listed above are applicable at each of the different EMRLs 302.

Each criteria 304 may correspond to one or more metrics 306. Generally, each metric 306 corresponds to a different producibility subcategory, and a given criteria 304 may include any number of metrics 306. Although not a requirement of the invention, the following are examples of metrics that are suitable for use in connection with the seven criteria 304 set forth above.

Design Producibility: Form, Fit, and Function; Custom Components; Key Characteristics; and Producibility Program. In the context of an example embodiment, “Form, Fit and Function” refers to the physical characteristics of the product, “Custom Components” refers to those items that are uniquely required and not commercially available, “Key Characteristics” refers to design features that require control during the production process, and “Producibility Program” refers to demonstrated evidence of an established organization that affects product producibility, e.g., the ability of an organization and its people, tools, and processes that ensure a repeatable and predictable outcome. Each metric will require the supplier to provide evidence of compliance, i.e., how many producibility requirements has the supplier met, which indicates their level of producibility process maturity.

Design to Cost: Design to Cost (the example embodiment utilizes only one metric 306 for the Design to Cost criteria 304). In this context, the “Design to Cost” metric 306 refers to meeting design cost targets, e.g., average unit production costs (“AUPC”) and cost reduction initiatives implemented to drive costs down to those targets. The measurement will determine how close the supplier is to their AUPC targets.

Industrial Base and Facilities: IB/Facilities (the example embodiment utilizes only one metric 306 for the Industrial Base and Facilities criteria 304). In this context, the “IB/Facilities” metric 306 refers to industrial base/facilities, capabilities, and capacities to meet program objectives. For example, this metric may be related to the question: “Has an industrial capabilities assessment been performed and does it meet program requirements?”

Materials: Availability; Materials Planning; Maturity; Sources; and Special Handling. In the context of an example embodiment, “Availability” refers to ease of procuring material used during production, “Materials Planning” refers to the sequencing of material needs and requirements, “Maturity” refers to the common use of a particular material, e.g., how long a particular material been used in the market, “Sources” refers to the manufacturers of the material, and “Special Handling” refers to unique procedures and processes used to fabricate, manufacture, assemble, transport, dispose of, or otherwise handle the material, e.g., OSHA, Department of Defense, or security concerns. Each metric will require the supplier to provide evidence of compliance, e.g., how many material requirements has the supplier met, which indicates its level of material process maturity.

Processes: Modeling and Simulation; Assembly Methods; Maturity; Manufacturing Technology Initiatives; Yields; and Special Skills. For the example embodiment, “Modeling and Simulation” refers to computer models used to simulate proposed factory assembly steps and flows, “Assembly Methods” refers to those steps used to build a product, “Maturity” refers to use of a particular process, e.g., how long has this process been used in the market, “Manufacturing Technology Initiatives” refers to government or company sponsored activities that reduce the risk of the introduction of new manufacturing technologies, “Yields” refers to the comparison between defective material versus accepted material for a given process, and “Special Skills” refers to any unique talents required to fabricate, assemble, integrate, and test hardware. Each metric will require the supplier to provide evidence of compliance, e.g., how many manufacturing related process requirements has the supplier met, which indicates its level of manufacturing process maturity.

Technical: Technical (the example embodiment utilizes only one metric 306 for the Technical criteria 304). In this context, the “Technical” metric 306 refers to a level of technology maturity, such as a TRL or an equivalent measurement.

Tooling/STE: Tooling (the example embodiment utilizes only one metric 306 for the Tooling/STE criteria 304). In this context, the “Tooling” metric 306 refers to the identification of equipment required to support the physical fabrication, assembly, and integration of the product and STE required to perform product validation. The metric is the identification of tooling and STE needed to meet program requirements.

In the example embodiment, each criteria 304 includes at least one metric 306, as depicted in FIG. 6. Moreover, in the example embodiment, the same set of metrics 306 applies to each individual EMRL 302. In other words, all of the metrics 306 listed above are applicable at each of the different EMRLs 302.

Each metric 306 may correspond to one or more requirements 308. Generally, each requirement 308 represents a different measurable producibility characteristic, and a given metric 306 may be associated with any number of requirements 308. In practice, requirements 308 represent the lowest measurable aspects of a project/program, where requirements 308 may impact the producibility of the resulting product, component, system, or technology. Metrics 306 are satisfied by requirements 308, which, in turn, are evidenced by artifacts 310. In the example embodiment, the set of requirements 308 is different at each EMRL 302. In this regard, each EMRL 302 may correspond to a different combination of requirements 308 and/or to a set of unique requirements 308. In other words, a given requirement 308 may apply to only one EMRL 302.

Referring again to FIG. 6, satisfaction (full or partial) of any given requirement 308 may be evidenced by a single artifact 310, multiple artifacts 310, a portion of one artifact 310, or portions of multiple artifacts 310 in combination. In other words, any given artifact 310 may be mapped to only one requirement 308, or to a plurality of requirements 308.

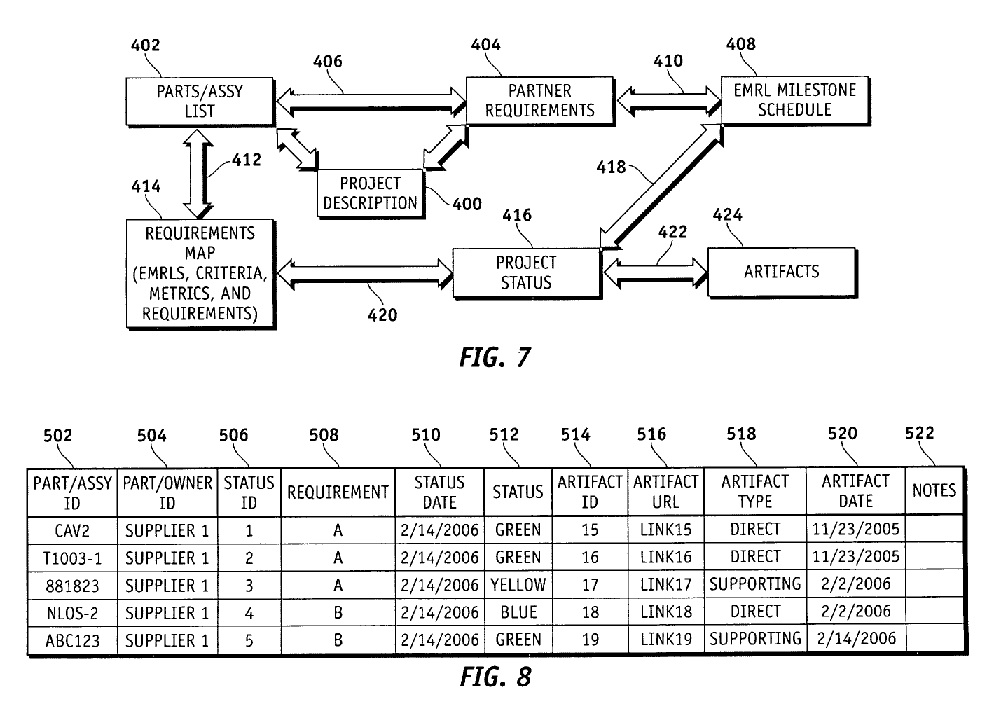

FIG. 7 is a relationship diagram depicting logical and functional links between elements, features, and components of an example EMAS, such as EMAS 100. FIG. 7 is an oversimplified rendition of the interrelationships present in an example EMAS, and it should be noted that the EMAS can be suitably configured to maintain and monitor a more complex map of relationships. As mentioned previously, the EMAS may utilize metadata to establish, maintain, and update the interrelationships shown in FIG. 7. As shown in FIG. 7, a given project will typically be associated with a detailed project description 400, which may provide the specifications and requirements for the project. Thus, project description 400 may include or be associated with a parts/assembly list 402. Project description 400 may also include or be associated with a list or definition of partner responsibilities 404. In this context, a partner can be any participant in the EMAS, including the project manager, lead system integrator, vendors, suppliers, designers, manufacturers, service providers, or the like.

In this example, each part, assembly, or component in parts/assembly list 402 is assigned to at least one partner. Accordingly, FIG. 7 depicts a part-to-partner link 406 that represents this relationship. As mentioned above, a project or program may have any number of developmental milestones, such as EMRLs, throughout its lifecycle. In practice, each EMRL may be associated with a specific date and the EMAS may maintain an EMRL milestone schedule 408 that includes the dates corresponding to each EMRL. Each partner in the project may have its own schedule, multiple partners may share one or more common schedules, or all partners may share the same schedule. Moreover, different schedules may apply to different parts, assemblies, or components in parts/assembly list 402. In this regard, FIG. 7 depicts a partner-to-schedule link 410 that represents the relationship between each partner and its respective EM schedule (or schedules).

As described above, the items on parts/assembly list 402 may be associated with requirements that enable the EMAS to monitor the health of the project from a producibility perspective. In this regard, FIG. 7 depicts a part-to-requirement link 412 that represents the relationship between parts/assembly list 402 and a requirements map 414 (e.g., a database or a logical structure that includes the requirements information). Link 412 establishes the correspondence between any given part and its requirements.

The EMAS is suitably configured to analyze and monitor the project status 416, and to generate project health or status reports as needed. In practice, the project status 416 at any given moment is related to the degree of satisfaction of the particular requirements for the specified EMRL. Accordingly, FIG. 7 depicts a schedule-to-status link 418 and a requirements-to-status link 420 that indicate the respective relationships between project status 416, EMRL milestone schedule 408, and requirements map 414. In addition, FIG. 7 depicts an artifact-to-status link 422 that represents the relationship between artifacts 424 (which provide evidence that partners are satisfying requirements) and project status 416.

FIG. 8 is a table of sample data and information handled by an example EMAS, such as EMAS 100. Each horizontal row in the table represents current data associated with a specific part, assembly, or component. FIG. 8 includes a rather short list of parts; a complex project may include hundreds or thousands of individual parts, components, or assemblies. As depicted in FIG. 8, for each part the EMAS may maintain any number of data elements, metadata, or identifiers organized in any suitable manner, including, without limitation: a part/assembly identifier 502; a part owner (i.e., partner) identifier 504; a status identifier 506; a requirement name or identifier 508; a status date 510; a current requirement status 512; an artifact name or identifier 514; an artifact link or URL 516; an artifact type identifier 518; an artifact date 520; and notes or comments 522. Of course, an example embodiment may be suitably configured to process more information, less information, or different information than that shown in FIG. 8.

The part/assembly identifier 502 may be an alphanumeric string or any designator that identifies a part, assembly, component, subsystem, system, or feature of the project. Although not depicted in FIG. 8, the EMAS may be configured to associate “child” parts to “parent” parts, where a child part can inherit the traits, properties, and requirement status of its associated parent part. For example, if a parent part is an assembly, then the individual components of the assembly may be designated as child parts. The part owner identifier 504 may be an alphanumeric string or any designator that identifies the responsible partner for the corresponding part/assembly identifier 502. For simplicity, all of the part/assembly identifiers 502 in FIG. 8 are assigned to the same partner, namely, “Supplier 1.” Although not shown in FIG. 8, an example EMAS may also maintain other information for each partner, e.g., a company name, address information, phone numbers, email addresses, the name of a point of contact or focal, etc. The status identifier 506 may be an alphanumeric string or any designator that uniquely identifies the status entry corresponding to the information in a given row in the table. In practice, an example EMAS may use unique status identifiers 506 to map to an artifact identifier and a requirement identifier in the system. The requirement identifier 508 may be an alphanumeric string or any designator that identifies the requirement to which the particular status entry pertains. In practice, each of the individual requirements is uniquely identified with a respective requirement identifier 508. Typically, part/assembly identifiers 502, part owner identifiers 504, and requirements 508 will remain mapped together throughout the lifecycle of the project, including tracking of part/assembly, owner, and requirements change mapping. The status identifiers 506 change each time a new status is entered, but (as with the other identifiers in the system) the status identifiers 506 are configuration managed and tracked under the rules that govern the system.

The status date 510 may be an alphanumeric string or any designator that indicates the date for the current status entry. In this regard, the status date 510 for a given part/assembly identifier 502 can be updated at any time to reflect any new status information that is entered into the EMAS. The current requirement status 512 may be an alphanumeric string or any designator that indicates the current requirement status for the respective part/assembly identifier 502. The example EMAS employs a color coded scheme for requirement status, which makes it easy for the EMAS to generate reports, charts, and graphs that can be quickly interpreted by a user. One practical color coding scheme employs five different colors: white=no information is available or the partner has not entered any information yet; red=the partner has taken no action, no action will be taken, or the corresponding artifact(s) do not satisfy the requirement; yellow=the partner intends to satisfy the stated requirement within the scheduled time frame; green=the stated requirement has been satisfied 100%, and the corresponding artifact(s) have been uploaded into the EMAS; blue=the stated requirement has been satisfied 100%, the corresponding artifact(s) have been uploaded into the EMAS, and the partner has shown that the stated requirement is integrated into its business as a “best practice” (or an equivalent). Ideally, at each EMRL, the status of all requirements will be green or blue.

A single artifact may be linked to any number of parts and/or to any number of requirements. The artifact identifier 514 may be an alphanumeric string or any designator that identifies the artifact corresponding to the information in a given row in the table. In practice, an example EMAS may use the artifact identifiers 514 to map to a status identifier 506. When a new artifact is entered it receives a unique artifact identifier 514, which may also be associated with a prior version of the artifact. The artifact URL 516 may be an alphanumeric string or any designator that indicates an active link to an uploaded artifact file. In the example embodiment, artifact URLs 516 are generated as active links on the system display terminals to enable users to access the uploaded artifacts. In other words, the EMAS may generate hyperlinks that represent or include URLs 516 that link to artifact files stored in one or more system databases.

The artifact type identifier 518 may be an alphanumeric string or any designator that indicates a type for the artifact corresponding to the information in a given row in the table. The example embodiment handles two different types of artifacts: direct artifacts and supporting artifacts. As used here, a direct artifact is a document or file that is specifically created to satisfy a requirement of the project. As used here, a supporting artifact is a document or file that is created outside of the context of the project. Supporting artifacts, although not specifically generated to satisfy a requirement of the project, still evidence satisfaction of one or more requirements.

The artifact date 520 may be an alphanumeric string or any designator that indicates the date that the respective artifact was entered or uploaded into the system. In this regard, the artifact date 520 for a given part/assembly identifier 502 may be updated at any time to reflect any revisions or modifications to an existing artifact. Notes 522 may be any alphanumeric information entered by users of the system, such as comments, reminders, explanations, or the like.

An EMAS configured in accordance with an example embodiment of the invention may be utilized by any type or category of participant, subject to management and control by the lead system integrator. For example, the lead system integrator will typically serve as the program manager and maintainer of the EMAS. These different types, levels, or categories of participant can be illustrated in the following manner:

0—system of systems level (typically the LSI)

1—element level (e.g., manned ground vehicles)

2—component level (e.g., an integrated command vehicle)

3—sub-component level (e.g., vehicle platform)

4—assembly level (e.g., armor, structure, communications)

5—item level (e.g., fuel systems, GPS, hull)

A one team partner, supplier, or the like, could be associated with any of the levels and, depending on the user perspective, the associations can be as flexible as needed to any level. For example, supplier x, who is responsible for the GPS system (shown at the item level 5 above) might view itself at the level 0 having its own partners/suppliers etc. at the lower corresponding levels. Thus, these interrelationships create a Nth level from the highest system of systems level or from an LSI perspective.

Depending upon the level, the EMAS can generate status reports that indicate the project health in a context that is appropriate to that level. For example, the status of individual parts, which is important at the subsystem level, may not be of critical importance at the one-team partner level. As another example, a partner at the variant level may be more interested in systemic producibility issues rather than the project health of any specific subsystem or part.

As mentioned previously, an example EMAS can be suitably configured to provide an automated and systematic methodology for measuring producibility. In practice, an EMAS can assure that the processes are in place to effect producibility, and can assure that such processes are being implemented throughout the design phases (such that the EMAS can significantly influence the total lifecycle cost of the program). In addition, an EMAS can evaluate if the processes in place are effectively minimizing development cost and addressing issues that will effect the product throughout its lifecycle. Furthermore, an EMAS as described herein provides early detection of potential risks and systemic issues during the design phase, identifies areas where a supplier may need help, identifies possible solutions, provides a collaborative approach to monitor progress towards milestone reviews, and facilitates quick distribution of relevant status information among the collaborative participants.

In connection with one practical EMAS deployment, the general governing business rules are as follows:

Criteria creation—the lead system integrator is the only source authorized to create or define criteria.

Part creation—suppliers and partners are the only sources authorized to create or modify a part, component, assembly, or feature of the project.

Artifact creation—suppliers, partners, and the lead system integrator are the sources authorized to create or modify artifacts.

Applying criteria to a part—criteria-to-part links are determined by suppliers and/or partners.

Artifact satisfying criteria—suppliers and/or partners are the only sources authorized to determine which parts are satisfied by a given artifact.

Status update—a status update is determined by suppliers and/or partners, and is concurred with the lead system integrator.

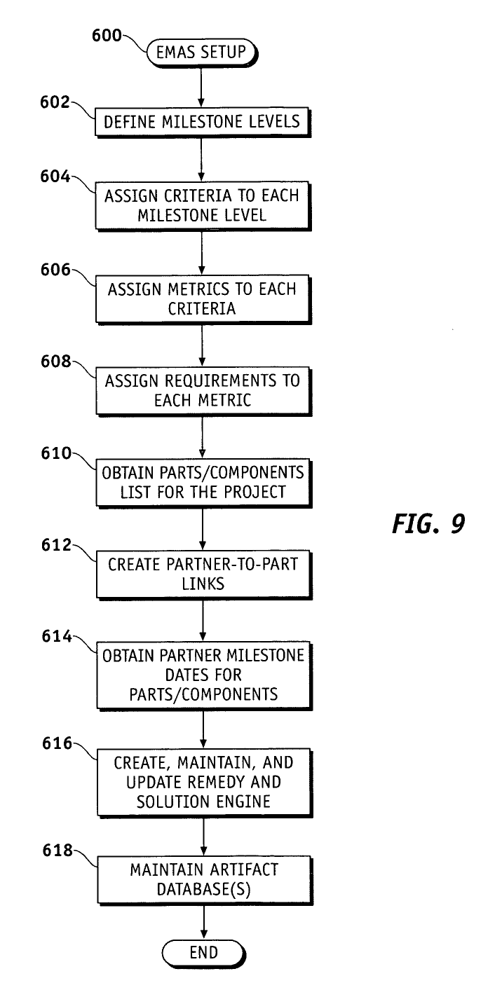

FIG. 9 is a flow chart of an example EMAS setup process 600 that may be performed for a project or program being managed by an EMAS as described herein. The various tasks performed in connection with process 600 may be performed by software, hardware, firmware, or any combination thereof. For illustrative purposes, the following description of process 600 may refer to elements mentioned above in connection with FIGS. 1-8. In embodiments of the invention, portions of process 600 may be performed by different elements of the described system, e.g., the program manager system, a database architecture, or a participant system. It should be appreciated that process 600 may include any number of additional or alternative tasks, the tasks shown in FIG. 9 need not be performed in the illustrated order, and process 600 may be incorporated into a more comprehensive procedure or process having additional functionality not described in detail herein.

EMAS setup process 600 may begin by defining milestone levels (e.g., EMRLs) applicable to the project (task 602). In the example embodiment, the EMRLs are predefined by the EMAS application. Process 600 may also assign criteria to each milestone level (task 604). As described above, each EMRL is associated with the same set of criteria in the example embodiment. Process 600 may also assign metrics to each criteria (task 606). As described above, each EMRL is associated with the same set of metrics in the example embodiment. Process 600 may also assign requirements to each metric (task 608). As described above, each metric for a particular EMRL is associated with one or more requirements. Ultimately, process 600 assigns requirements to the plurality of milestone levels, where each of the requirements corresponds to a measurable producibility characteristic.

EMAS setup process 600 may also obtain (task 610) and maintain an electronic parts/components list for the project. In the example embodiment, process 600 obtains the parts/components list from one or more participants in the EMAS. In addition, process 600 may create partner-to-part links (task 612) for the parts in the parts/components list. Task 612 represents an assignment of responsibility for the parts to one or more partners or participants in the EMAS. In practice, each partner may have one or more respective milestone schedules for its responsible parts. Accordingly, process 600 may obtain partner milestone dates (task 614) for the various parts, components, assemblies, and subsystems. In this regard, the EMAS may be configured to monitor a vast number of different milestone schedules that are mapped to different partners and/or to different parts.

In the example embodiment, EMAS setup process 600 creates, maintains, and updates a remedy and solution engine (task 616), which may be realized in the program manager system as described above in connection with FIG. 5. Task 616 may leverage expert system technologies, leverage neural networking technologies, utilize empirical observation data, and receive user-entered information or data. In addition, process 600 may create, maintain, and manage (task 618) one or more databases of artifact files. As described above, such databases are preferably accessible to certain participants in the EMAS.

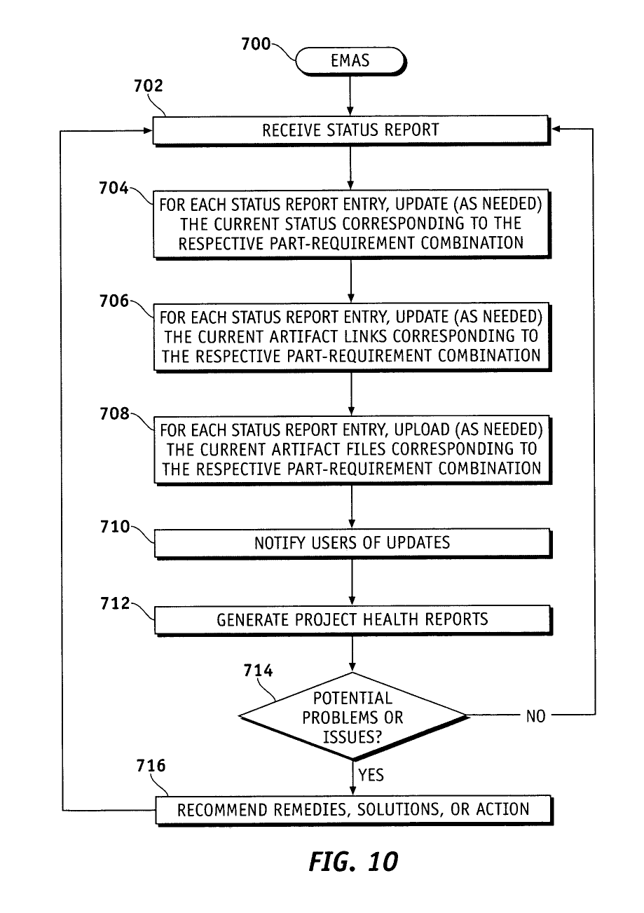

FIG. 10 is a flow chart of an example EMAS process 700 that may be performed by an EMAS as described herein. The various tasks performed in connection with process 700 may be performed by software, hardware, firmware, or any combination thereof. For illustrative purposes, the following description of process 700 may refer to elements mentioned above in connection with FIGS. 1-8. In embodiments of the invention, portions of process 700 may be performed by different elements of the described system, e.g., the program manager system, a database architecture, or a participant system. It should be appreciated that process 700 may include any number of additional or alternative tasks, the tasks shown in FIG. 10 need not be performed in the illustrated order, and process 700 may be incorporated into a more comprehensive procedure or process having additional functionality not described in detail herein.

EMAS process 700 assumes that the EMAS system has already been initialized and configured as described above. In other words, process 700 assumes that the EMAS system is ready to receive and process information such as status data. Accordingly, process 700 may begin by receiving a status report (task 702) or any suitably formatted status information. In this example, the status report contains entries for one or more parts on a parts list (see FIG. 8), and the status information conveyed in the status report may include a current requirement status for one or more part-requirement combinations. Again, unique part-requirement combinations may be tracked because a given part may be linked to any number of requirements at the particular EMRL. The current requirement status indicates a degree of satisfaction of a specified requirement that impacts producibility of the product, component, system, or technology. For example, the current requirement status may indicate one of the five colors listed above in the description of FIG. 8.

For each status report entry, EMAS process 700 may update (if necessary) a previously stored requirement status for the respective part-requirement combination (task 704) and/or a previously stored artifact link or links for the respective part-requirement combination (task 706). Task 704 may be performed to ensure that the electronically maintained status data reflects the current requirement status for that particular part-requirement combination. Of course, if the requirement status has not changed, then task 704 can be bypassed. Task 706 may be performed to ensure that the electronically maintained status data reflects any new or revised artifact links, which may be related to newly posted or created artifacts, related to previously posted or created artifacts that have been modified, and/or related to previously posted or created artifacts that are being accessed via a new links. In connection with task 706, process 700 may also provide active links for access to the artifact files. If the artifact link data has not changed, then task 706 can be bypassed.

In example embodiments, the status report may include one or more electronic artifact files. For each status report entry, EMAS process 700 may also upload (as needed) artifact files for the respective part-requirement combination (task 708). Task 708 enables process 700 to store artifact files in a suitable database location. Thus, the EMAS can manage one or more databases of artifact files in an ongoing manner. In connection with task 708, process 700 may perform an appropriate mapping between any new or updated artifact links and the corresponding artifact files. Such mapping enables users of the EMAS to access stored artifact files via respective artifact links (such as URLs) displayed at the user display terminals. If no artifacts are included in the status report, then task 708 is bypassed.

In response to the posting of new status information, a status update, a new status report, or the like, EMAS process 700 may generate (task 710) a notification of the status information for participants in the project. The EMAS may use any technique or method to generate and transmit such notifications, e.g., an email, a pager message, an instant message, a voicemail, or the like. This notification feature enables the EMAS to notify participants in substantially real-time such that the participants can view the current status of the project at any time during the lifecycle of the project.

EMAS process 700 is also capable of generating a project health report (or any number of reports) that is influenced by the status information (task 712). As described above in connection with report generator 212 (see FIG. 5), an EMAS system may be suitably configured to prepare, distribute, and/or provide access to any number of status, health, and other reports, which may be formatted to suit the needs of the specific project or to accommodate user preferences. The EMAS is able to view status information arranged by part identifiers, arranged by partners, arranged by projects, and arranged over time. The EMAS may generate spread sheet reports, pie chart reports, graphs, tables, or the like.

As one example, the EMAS may generate a “Data View” report for a selected project, a selected partner, and a selected EMRL. This report will include a listing of all parts/assemblies for which the selected partner is responsible, and a breakdown of the current requirement status in terms of the five possible color codes. For example, for an assembly such as a truck, the report may indicate 9% blue, 3% green, 58% yellow, 5% red, and 25% white for the requirements corresponding to the selected EMRL.

As another example, the EMAS may generate a “Criteria View” report for a selected project, a selected partner, and a selected EMRL. This report will include a listing of the seven criteria along with a breakdown of the current requirement status for all products for which the selected partner is responsible. The breakdown may indicate a product count and/or percentage for each of the five possible color codes. For example, the Criteria View report may indicate that the selected partner currently has 10 products having a blue status, 1 product having a green status, 51 products having a yellow status, 5 products having a red status, and 17 products having a white status (all corresponding to the Design Producibility criteria). The Criteria View report may indicate similar information for all seven criteria.

The EMAS may also generate similar reports that concentrate on metrics or requirements. In addition, the EMAS may generate summary reports that focus on a particular partner, specific parts, or the like. Those skilled in the art will recognize that the data handled by the EMAS can be manipulated and arranged in any suitable manner to suit the needs of the participants.

In the example embodiment, the EMAS may perform an automated analysis of project health or status to identify potential problems and/or issues that may adversely affect producibility of the product, element, subsystem, technology, component, or system. The EMAS can analyze and view systemic issues over different products and programs to determine whether there exists an enterprise-wide manufacturing problem, whether there exists a systemic problem with a given vendor, and whether there exists a systemic problem related to a given process, materials, or the like. The EMAS can quickly and efficiently correlate data across status levels, artifacts, programs, vendors, parts, etc. In practice, the EMAS system can monitor the project health and status in real-time such that potential problems/issues can be flagged as soon as they are detected rather than at some arbitrary design review meeting or milestone. If no potential problems/issues are detected, then process 700 may be re-entered at task 702 to wait for the next status report. If, however, process 700 detects a potential problem/issue, then the EMAS may generate a recommended remedy, solution, or action plan (task 716) that addresses the potential problem/issue. For example, the EMAS may generate and distribute a notification to appropriate participants as a warning, suggest remedial action, or trigger an automated diagnostic procedure that analyzes status information in more detail. In practice, remedial action may include, without limitation: generating a list of possible enablers, such as design for manufacturing and assembly, lean, virtual manufacturing and assembly, links to government and company sponsored projects to improve manufacturing processes. Following task 716, process 700 may be re-entered at task 702 to wait for the next status report.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A system comprising:
a relationship network with a plurality of addressable nodes each being addressed through a plurality of address elements;
a plurality of metadata each being associated with a node which defines a relationship between the address elements; and
an analyzing block being capable of analyzing the metadata associated to a given node against a requirement assigned to that node and providing a result.

2. The system of claim 1 wherein the plurality of address elements are at least three elements.

3. The system of claim 2 wherein the at least three elements are partners, products, and schedule.

4. The system of claim 1, wherein providing a result is assigning a status level to the metadata.

5. The system of claim 1, wherein providing a result is identifying a problem and providing a solution.

6. The system of claim 1, wherein providing a result is identifying a problem and pointing to a source of solution.

7. The system of claim 1, wherein each requirement is an EMRL.

8. The system of claim 1, wherein each requirement is an TRL.

9. The system of claim 1, wherein each requirement is an SRL.

10. The system of claim 1, wherein each requirement is an ICA.

11. The system of claim 1, wherein each requirement is an BRL.

12. A method of managing a project comprising:
defining a plurality of relationships between a plurality of elements of the project;
associating a metadata to each relationship;
assigning requirements to each relationship; and
analyzing the metadata associated with a given relationship against the requirements assigned to that relationship and providing a result.

13. The method of claim 12 wherein the plurality of elements of the project are at least three elements.

14. The method of claim 13 wherein the at least three elements are partners, products, and schedule.

15. The method of claim 12, wherein providing a result is assigning a status level to the metadata.

16. The method of claim 12, wherein providing a result is identifying a problem and providing a solution.

17. The method of claim 12, wherein providing a result is identifying a problem and pointing to a source of solution.

18. The method of claim 12, wherein each requirement is an EMRL.

19. The method of claim 12, wherein each requirement is an TRL.

20. The method of claim 12, wherein each requirement is an SRL.

21. The method of claim 12, wherein each requirement is an ICA.

22. The method of claim 12, wherein each requirement is an BRL.

23. A method of managing a project comprising:
defining a plurality of relationships between a plurality of entities and a plurality of different type elements related to a project;
associating a metadata to each relationship for providing information related to at least one of the plurality of entities with respect to the plurality of different type elements of the project;
assigning requirements to each relationship; and
analyzing the metadata associated with a given relationship against the requirements assigned to that relationship and providing a result.

24. The system of claim 23 wherein the plurality of different type elements are at least two elements.

25. The system of claim 24 wherein the at least two elements are products, and schedule.

26. The system of claim 24 wherein the at least two elements are services, and schedule.
